(19) United States
(12) Patent Application Publication
(10) Pub. No.: US 2025/0209830 A1
(43) Pub. Date: Jun. 26, 2025

(54) IMAGE PROCESSING DEVICE, IMAGE PROCESSING METHOD, AND STORAGE MEDIUM

(71) Applicant: HONDA MOTOR CO., LTD., Tokyo (JP)

(72) Inventor: Akira Kanehara, Wako-shi (JP)

(21) Appl. No.: 18/999,192

(22) Filed: Dec. 23, 2024

(30) Foreign Application Priority Data
Dec. 25, 2023 (JP) 2023-218586

(51) Int. Cl. G06V 20/56; G06T 3/00; G06V 10/40

(52) U.S. Cl. CPC G06V 20/588; G06T 3/00; G06V 10/40

(57) ABSTRACT

An image processing device of an embodiment includes an acquirer configured to acquire an image in a periphery of a mobile object, an extractor configured to extract feature points from an image acquired, a first detector configured to detect a moving road area in which the mobile object moves based on the image, a second detector configured to detect a cross road area that crosses the moving road area based on the image, a first feature point extractor configured to extract a feature point of a moving road area detected by the first detector as a first feature point among feature points extracted, a second feature point extractor configured to extract a feature point of a cross road area detected by the second detector as a second feature point among the feature points, and a calibrator configured to calibrate the image based on the first and the second feature point.

### CROSS-REFERENCE TO RELATED APPLICATION

Priority is claimed on Japanese Patent Application No. 2023-218586, filed Dec. 25, 2023, the content of which is incorporated herein by reference.

### BACKGROUND

### Field of the Invention

The present invention relates to an image processing device, an image processing method, and a storage medium.

### Description of Related Art

In recent years, there has been increased effort to provide an access to sustainable transport systems that take into consideration vulnerable transport participants. To realize this, research and development to further improve the safety and convenience of traffic through research and development related to driving support technology has been mainly focused on. In relation to this, a technology is known in which a captured image is acquired from a camera mounted on a mobile object, feature points are extracted from an extract area of the acquired captured image that is set or changed on the basis of an external environment of the mobile object in an image-capturing direction of the camera, and a posture of the camera is estimated based on the extracted feature points (for example, refer to Japanese Unexamined Patent Application, First Publication No. 2021-33605).

### SUMMARY

However, driving assistance technology has an issue in that it may not be possible to perform proper calibration on captured images due to factors such as misalignment of an imaging device attached to a mobile object or a product variation in the imaging device.

To solve the issue described above, one of objects of the present application is to provide an image processing device, an image processing method, and a storage medium that can perform more appropriate calibration on images captured by an imaging device mounted on a mobile object. This will ultimately contribute to the development of a sustainable transportation system.

The image processing device, image processing method, and storage medium according to the present invention have adopt the following configuration.
(1): An image processing device according to one aspect of the present invention includes an acquirer configured to acquire an image in a periphery of a mobile object from an imaging device mounted on the mobile object, an extractor configured to extract feature points from an image acquired by the acquirer, a first detector configured to detect a moving road area in which the mobile object moves based on the image, a second detector configured to detect a cross road area that crosses the moving road area based on the image, a first feature point extractor configured to extract a feature point of a moving road area detected by the first detector as a first feature point among feature points extracted by the extractor, a second feature point extractor configured to extract a feature point of a cross road area detected by the second detector as a second feature point among the feature points, and a calibrator configured to calibrate the image on the basis of the first feature point and the second feature point.
(2): In the aspect of (1) described above, the acquirer may use the imaging device to acquire at least an image of a view in a forward direction of the mobile object and an image of a view in a direction different from the forward direction.
(3): In the aspect of (1) described above, the calibrator may calibrate an image of the mobile object in a pitch direction on the basis of the first feature point, and calibrate an image of the mobile object in a roll direction on the basis of the second feature point.
(4): In the aspect of (1) described above, the calibrator may calibrate a coordinate system of the image when a first feature point in the cross road area and a second feature point in the moving road area are extracted over a predetermined number of consecutive frames or more from image frames acquired by the acquirer in a predetermined cycle.
(5): In the aspect of (1) described above, the calibrator may calibrate coordinate conversion parameters that convert from an image coordinate system based on the view in the forward direction of the mobile object included in the image to a bird's-eye view coordinate system in which the mobile object is viewed from above.
(6): In the aspect of (1) described above, the imaging device may be integrally configured to include an imager that captures an image of view in the forward direction of the mobile object and an imager that captures an image of a view in a direction different from the forward direction.
(7): An image processing method according to another aspect of the present invention includes, by a computer, acquiring an image in a periphery of a mobile object from an imaging device mounted on the mobile object, extracting feature points from the acquired image, detecting a moving road area in which the mobile object moves based on the image, detecting a cross road area that crosses the moving road area based on the image, extracting a feature point of the moving road area as a first feature point among the extracted feature points, extracting a feature point of the cross road area as a second feature point among the feature points, and calibrating the image on the basis of the first feature point and the second feature point.
(8): A storage medium according to still another aspect of the present invention is a computer-readable non-transient storage medium that has stored a program causing a computer to execute acquiring an image in a periphery of a mobile object from an imaging device mounted on the mobile object, extracting feature points from the acquired image, detecting a moving road area in which the mobile object moves based on the image, detecting a cross road area that crosses the moving road area based on the image, extracting a feature point of the moving road area as a first feature point among the extracted feature points, extracting a feature point of the cross road area as a second feature point among the feature points, and calibrating the image on the basis of the first feature point and the second feature point.

According to the aspects of (1) to (8) described above, it is possible to perform more appropriate calibration on images captured by an imaging device mounted on a mobile object.

### BRIEF DESCRIPTION OF THE DRAWINGS

FIG. 1 is a diagram which shows an example of a functional configuration of a driving assistance device including an image processing device of an embodiment.

FIG. 2A is a diagram which shows an example of an installation position of an imaging device.

FIG. 2B is a diagram which shows an example of a configuration of the imaging device.

FIG. 3 is a diagram for describing imaging directions of a front camera and a rear camera.

FIG. 4 is a diagram which shows an example of an image captured by the imaging device.

FIG. 5 is a diagram for describing coordinate conversion processing in the embodiment.

FIG. 6 is a flowchart which shows an example of a flow of processing executed by the image processing device of the embodiment.

### DESCRIPTION OF EMBODIMENTS

Hereinafter, an embodiment of an image processing device, an image processing method, and a storage medium of the present invention will be described with reference to the drawings. In the following example, an image processing device mounted on a mobile object will be described. The mobile object may include any mobile object on which a person (an occupant such as a driver) rides, including a three-wheeled or four-wheeled vehicle, a two-wheeled vehicle, a micromobility, and the like. The mobile object may be equipped with a driving assistance device that assists the occupant (driver) of the mobile object in driving on the basis of an image processed by the image processing device. In the following description, the mobile object is a four-wheeled vehicle (hereinafter referred to as a “vehicle M”) and is equipped with a driving assistance device. The vehicle M may be any of an automobile powered by an internal combustion engine such as a diesel engine or a gasoline engine, an electric automobile powered by an electric motor, or a hybrid automobile equipped with both an internal combustion engine and an electric motor. In the following description, a forward direction of the vehicle M is a plus X direction, a rearward direction of the vehicle M is a minus X direction, a right direction based on the plus X direction, which is a width direction of the vehicle M, is a plus Y direction, a left direction is a minus Y direction, and a height direction of the vehicle M which is orthogonal to the X and Y directions is a plus Z direction.

### [Configuration]

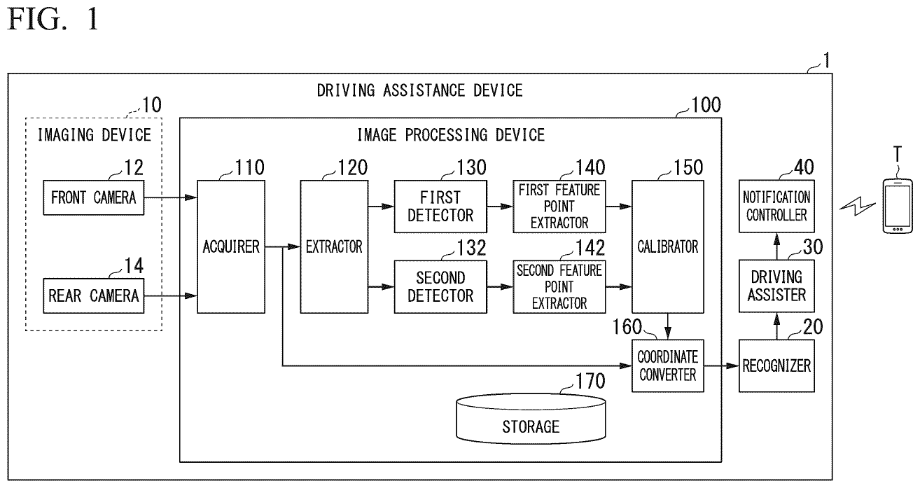

FIG. 1 is a diagram which shows an example of a functional configuration of a driving assistance device 1 including an image processing device of an embodiment. The driving assistance device 1 shown in FIG. 1 includes, for example, an imaging device 10, a recognizer 20, a driving assister 30, a notification controller 40, and an image processing device 100. The recognizer 20, the driving assister 30, the notification controller 40, and the image processing device 100 are realized by, for example, a hardware processor such as a central processing unit (CPU) executing a program (software). Some or all of these components may be realized by hardware (a circuit portion; including circuitry) such as a large scale integration (LSI), an application specific integrated circuit (ASIC), a field-programmable gate array (FPGA), a graphics processing unit (GPU), or a system on chip (SOC), or may be realized by software and hardware in cooperation. The program may be stored in advance in a storage device (a storage device having a non-transient storage medium) such as a hard disk drive (HDD) or a flash memory, or may be stored in a removable storage medium (a non-transient storage medium) such as a DVD or a CD-ROM, and may be installed by the storage medium being attached to a drive device. The vehicle M of the embodiment includes, in addition to the constituents of FIG. 1, constituents for causing the vehicle M to travel (for example, a driving operator, a drive device such as an engine or a motor, a steering device, a brake device, and a vehicle sensor), and the like.

The imaging device 10 captures an image of a periphery of the vehicle M. For example, the imaging device 10 is a digital camera using a solid-state imaging element such as a charge coupled device (CCD) or a complementary metal oxide semiconductor (CMOS). The imaging device 10 may be a stereo camera. The imaging device 10 may be, for example, a camera used in a drive recorder or the like. In the example of FIG. 1, the imaging device 10 includes a front camera 12 and a rear camera 14 as a plurality of imagers. The front camera 12 captures an image of a predetermined area in the forward direction of the vehicle M. The rear camera 14 captures an image of a predetermined area in a direction different from the forward direction (for example, a rearward direction of the vehicle M). At least one of the front image captured by the front camera 12 and the rear image captured by the rear camera 14 may include an area of the vehicle M in a lateral direction. The imaging device 10 may be provided with a side camera that captures an image of the vehicle M in the lateral direction, in addition to the front camera 12 and the rear camera 14. Instead of the cameras described above, the imaging device 10 may be a fisheye camera capable of capturing images of the periphery including areas in the forward and rearward directions of the vehicle M at a wide angle (for example, 360 degrees). The imaging device 10 has each camera repeatedly capture images at a predetermined cycle and output the captured images to the image processing device 100.

The image processing device 100 acquires the images captured by the imaging device 10 and performs processing to convert a coordinate system of an image (hereinafter, a camera coordinate system) into a coordinate system different from the camera coordinate system. The camera coordinate system includes a front camera coordinate system corresponding to the front image and a rear camera coordinate system corresponding to the rear image. The coordinate system different from the camera coordinate system is, for example, a coordinate system based on a position of the vehicle M when viewed from above (a vehicle coordinate system or a bird's-eye view coordinate system).

The image processing device 100 includes, for example, an acquirer 110, an extractor 120, a first detector 130, a second detector 132, a first feature point extractor 140, a second feature point extractor 142, a calibrator 150, a coordinate converter 160, and a storage 170.

The storage 170 may be realized by a storage device such as an HDD or a flash memory, or a solid state drive (SSD), an electrically erasable programmable read only memory (EEPROM), a read only memory (ROM), or a random access memory (RAM). For example, an image acquired by the acquirer 110, a result of processing by the calibrator 150 or the coordinate converter 160, a program, and various other types of information are stored in the storage 170. The storage 170 may store map information. The map information is, for example, information in which a road shape is expressed in association with positional information (latitude and longitude information) by links indicating roads and nodes connected by the links. The map information may include information on a curvature and a gradient of a road, the number of lanes, a width, and a center of the lanes, or lane boundary information such as road dividing lines that divide the lanes. The map information may include traffic regulation information, positional information on branches, junctions, crossover points, T-junctions, and the like, facility information such as buildings or parking lots, point of interest (POI) information, and the like. The map information may be updated at any time by the vehicle M or the driving assistance device 1 communicating with other devices.

The acquirer 110 acquires image frames of front images and rear images captured by the imaging device 10 at a predetermined cycle. The extractor 120 extracts feature points included in the front images and rear images acquired by the acquirer 110. For example, the extractor 120 performs known image analysis processing such as edge extraction processing on the front images and rear images, and extracts feature points of objects in real space included in the images (for example, traffic signals, road signs, traffic participants such as pedestrians and other vehicles, buildings, as well as road division lines, stop lines, and the like) on the basis of results of the image analysis processing. In this case, the extractor 120 extracts, for example, a sequence of points on an edge of an object included in the image as feature points (groups of feature points). A method of extracting feature points on an image is not limited to the example described above, and other known methods may be used. For example, when a front image or a rear image is input, the extractor 120 may extract feature points using a learned model that has been learned to output the edges of objects (for example, buildings, road structures, and the like) depicted in the image as a point group. The learned model may be stored in the storage 170 in advance, or may be acquired from an external device via a communication device (not shown) mounted in the vehicle M. The extractor 120 may extract feature points using, for example, a visual simultaneous localization and mapping (SLAM) method, which is a technology for grasping the vehicle's own position in three dimensions based on image data captured by the imaging device 10.

The first detector 130 detects a host road area (an example of a moving road area) on which the vehicle M travels (moves) based on the front image and rear image. The second detector 132 detects a cross road area that crosses a host road based on the front image and rear image. The cross road is a road that is connected to the host road at a specified angle range including a right angle, for example, at a crossover point or T-junction. Processing of the first detector 130 and the second detector 132 will be described in detail below.

The first feature point extractor 140 extracts a feature point of the host road area detected by the first detector 130 from the feature points (the groups of feature points) extracted by the extractor 120 as the first feature points. The second feature point extractor 142 extracts, as a second feature point, a feature point in the cross road area detected by the second detector 132 from the feature points (a group of feature points) extracted by the extractor 120. The first feature point and the second feature point are feature points required for image calibration in the embodiment. Details of processing of the first feature point extractor 140 and the second feature point extractor 142 will be described below.

The calibrator 150 calibrates an image captured by the imaging device 10 on the basis of the first feature point extracted by the first feature point extractor 140 and the second feature point extracted by the second feature point extractor 142. For example, the calibrator 150 calibrates a coordinate conversion parameter that converts a coordinate system of the captured image from a camera coordinate system to a coordinate system (a bird's-eye view coordinate system) different from the camera coordinate system. As a result, it is possible to perform more appropriate coordinate conversion. Details of a function of the calibrator 150 will be described below. The calibrator 150 may cause the storage 170 to store information about a calibrated coordinate conversion parameter.

The coordinate converter 160 converts the coordinate system (camera coordinate system) of the image acquired by the acquirer 110 into another coordinate system. For example, the coordinate converter 160 converts the camera coordinate system into the bird's-eye view coordinate system used by the recognizer 20 to recognize a surrounding situation of the vehicle M. In this case, the coordinate converter 160 converts into bird's-eye view coordinates using the coordinate conversion parameter calibrated by the calibrator 150 for a reference coordinate conversion parameter previously stored in the storage 170 or the like.

The recognizer 20 recognizes the surrounding situation of the vehicle M on the basis of the image converted into the bird's-eye coordinate system by the coordinate converter 160 (hereinafter referred to as the “bird's-eye view image”). For example, the recognizer 20 recognizes objects present in a periphery of the vehicle M (within a predetermined distance from the vehicle M) on the basis of the bird's-eye view image. The objects include, for example, traffic participants such as other vehicles and pedestrians. The recognizer 20 recognizes a position (a relative position as viewed from the vehicle M), a speed (a relative speed as viewed from the vehicle M), a type, a shape, a size, and the like of an object. For example, object recognition using a model based on deep learning or deep machine learning, object recognition based on a pattern matching method, or an object recognition method that combines these is performed for object recognition.

The driving assister 30 provides driving assistance to an occupant of the vehicle M on the basis of a result of the recognition by the recognizer 20. For example, the driving assister 30 determines whether the vehicle M will deviate from a traveling lane of the vehicle M, which is divided by the road dividing lines recognized by the recognizer 20, and when there is a possibility of deviation, notifies a driver of the vehicle M via the notification controller 40, or controls steering of the vehicle M by a steering device (not shown) so as to suppress the deviation from the traveling lane of the vehicle M (so that the vehicle M moves toward a center of the traveling lane). The driving assister 30 recognizes an obstacle such as other vehicles present in the periphery of the vehicle M (within a predetermined distance), and when it is determined that there is a possibility of contact with the obstacle based on a relative position and a relative speed with respect to the obstacle, notifies the occupant using the notification controller 40, or executes traveling control (at least one of speed control and steering control) to avoid the contact.

The notification controller 40 notifies the occupant (driver) of the vehicle M of driving assistance based on the control by the driving assister 30. In this case, the notification controller 40 generates notification information such as a sound (an alarm) or an image associated with notification content to be notified to the occupant, and transmits the generated notification information to a terminal device T to output it.

Here, the terminal device Tis, for example, a portable terminal device such as a smartphone or tablet terminal used by a driver who drives the vehicle M equipped with the driving assistance device 1. In the terminal device T, for example, an application for receiving driving assistance by the driving assistance device 1 is executed. The application displays an image based on the information or notification transmitted by the driving assistance device 1 on a display of the terminal device T, or causes a speaker of the terminal device T to emit a sound. The terminal device Tis an example of a “notifier.” The terminal device Tis, for example, detachably attached to the vehicle M and used. For example, a holder for the terminal device T having a detachable part is provided on one or both of the terminal device T and the vehicle M, and the terminal device T is supported by a holder. In the embodiment, when devices such as a navigation device, a display device, and a speaker are mounted in the vehicle M, notification information may be output from the mounted devices instead of the terminal device T on the basis of an instruction from the driving assister 30.

### [Processing Up to Extraction of Feature Points]

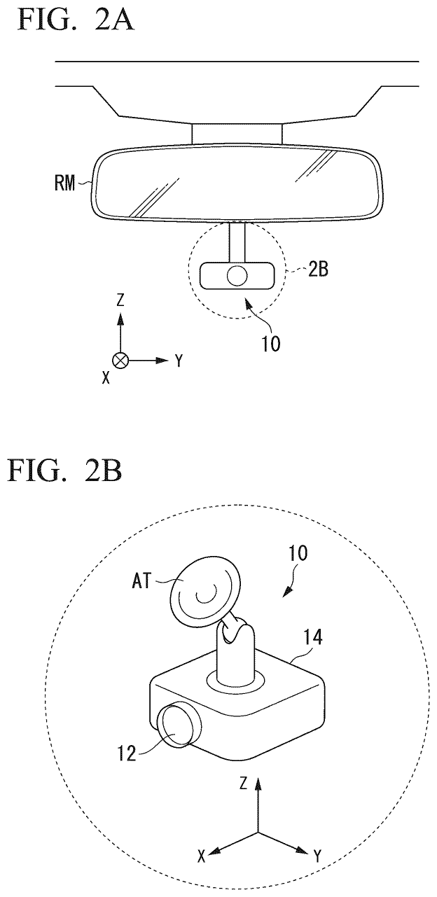

Next, a specific example of processing up to extraction of feature points from images (a front image and a rear image) acquired by the acquirer 110 will be described. FIG. 2A is a diagram which shows an example of an imaging device 10. The imaging device 10 of the embodiment is attached, for example, near a rearview mirror RM on an upper part of the front windshield (in the example of FIG. 2A, below the rearview mirror RM 2B). In the example of FIG. 2A, the imaging device 10 is attached to a lower part of the rearview mirror RM, but the position is not limited thereto, and it may be attached, for example, to a right or left side of the rearview mirror RM. FIG. 2B is a diagram which shows an example of a configuration of the imaging device 10. The imaging device 10 includes, for example, an attachment part AT that can be detachably attached to the vehicle M. The attachment part AT is, for example, any member such as a suction cup, a seal, or a support member such as a bracket. In the example of FIG. 2B, the imaging device 10 is provided with a front camera 12 and a rear camera 14 to capture images in different directions.

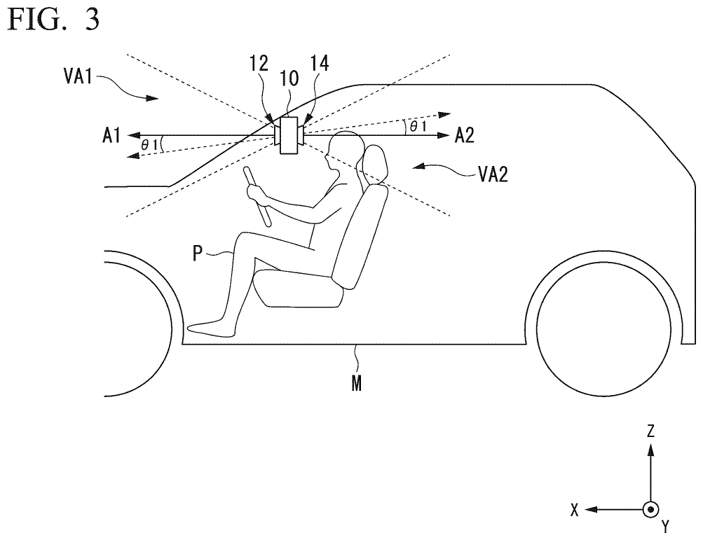

FIG. 3 is a diagram for describing imaging directions of the front camera 12 and the rear camera 14. As shown in FIG. 2B and FIG. 3 described above, the imaging device 10 has the front camera 12 and the rear camera 14 integrally configured within a predetermined distance. Being integrally configured may include, for example, a case where the front camera 12 and the rear camera 14 are stored in one housing, or a configuration where the front camera 12 and the rear camera 14 are connected (coupled) to each other. In this configuration, for example, when the front camera 12 captures an image of an area having a predetermined angle-of-view area VA1 centered on a front direction A1 of the vehicle M (a positive X-axis direction in FIG. 3), the rear camera 14 captures an image of an area having a predetermined angle-of-view area VA2 centered on a direction A2 opposite to the front direction A1 of the vehicle M. Therefore, when the front camera 12 captures an image of an angle-of-view area centered on a direction tilted downward at an angle θ1 with respect to the front direction A1 of the vehicle M as a reference due to a misalignment caused by some factors during or after installation, the rear camera 14 captures an image of an angle-of-view area centered on a direction tilted upward at an angle θ1 with respect to a direction A2 opposite to the front direction A1 as a reference. In the embodiment, when a misalignment occurs in the imaging direction (angle of view) of one of the front camera 12 and the rear camera 14 which are integrally configured, a similar misalignment occurs in the imaging direction (angle of view) of the other camera in a symmetrical direction centered on an installation position of the imaging device 10.

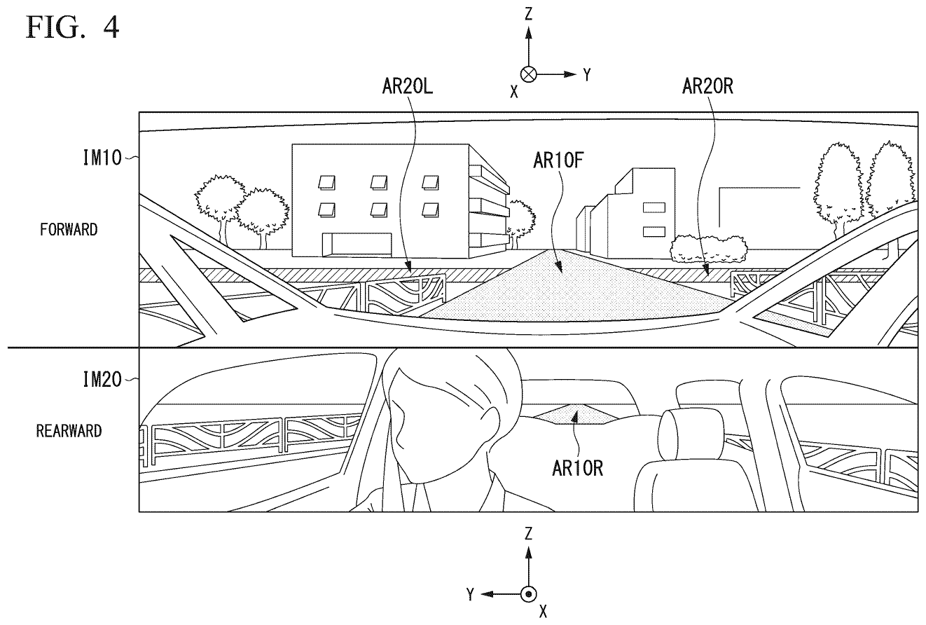

FIG. 4 is a diagram which shows an example of an image captured by the imaging device 10. In the example of FIG. 4, a front image IM10 captured by the front camera 12 and a rear image IM20 of the vehicle M captured by the rear camera 14 are shown. The front image IM10 has a captured area outside the vehicle (in the forward direction of the vehicle M) through a front windshield of the vehicle M. The rear image IM20 has a captured rear area including an interior of the vehicle, and has a captured area outside the vehicle (in a sideward or the rearward direction of the vehicle M) through a side windshield and a rear windshield.

The extractor 120 extracts a plurality of feature points (groups of feature points) from the front image IM10 and the rear image IM20 shown in FIG. 4. For example, the extractor 120 extracts feature points for each image frame of the front image IM10 and the rear image IM20 acquired at a predetermined cycle.

The first detector 130 detects the host road area in images based on the front image IM10 and the rear image IM20. For example, the first detector 130 acquires left and right road dividing lines of the vehicle M on the basis of a portion of the sequence of points included in the group of feature points extracted by the extractor 120, and detects an area divided by the acquired road dividing lines as the host road area. For example, the first detector 130 may divide the front image IM10 and the rear image IM20 into a plurality of divided areas and detect the host road area for each divided area. As shown in the front image IM10 and the rear image IM20 in FIG. 4, a position where the host road area is present on each image is near a center of the image, which is easy to predict to some extent. Therefore, the first detector 130 may detect the host road area based on a group of feature points for a partial area of the front image IM10 and the rear image IM20 where it is predicted in advance that the host road area is likely to be present (for example, a predetermined area including the center of the image). As a result, it is possible to reduce a processing load related to the detection of the host road area.

The first detector 130 may, for example, realize a function of AI (Artificial Intelligence) and a function of a predefined model in parallel. For example, a function of “detecting the host road area” may be realized by detecting the host vehicle road area using deep learning or the like and detecting the host vehicle road area using predefined determination processing (for example, determination processing based on pattern matching) in parallel for the front image IM10 and the rear image IM20, and scoring both of them to evaluate them comprehensively.

In the example of FIG. 4, the first detector 130 detects a host road area AR10F in the forward direction of the vehicle M based on the front image IM10, and detects a host road area AR10R in the rearward direction of the vehicle M based on the rear image IM20.

The second detector 132 detects the cross road area in the image based on the front image IM10 and the rear image IM20. For example, the second detector 132 detects a sequence of points that is in contact with the host road area detected by the first detector 130 at a predetermined angle on the basis of the portion of the sequence of points included in the group of feature points extracted by the extractor 120. The predetermined angle is, for example, a predetermined angle range (for example, about 75 to 105 degrees) including 90 degrees (right angle) with respect to an extension direction of the host road area. Then, when two sequences of points are present in parallel within a predetermined distance (including an allowable error range), the second detector 132 detects the two sequences of points as a road dividing line and detects an area divided by the road dividing line as a cross road area.

For example, the second detector 132 may divide the front image IM10 and the rear image IM20 into a plurality of divided areas and detect a cross road area for each divided area. The second detector 132 may detect a cross road area based on the group of feature points for a partial area of the front image IM10 and the rear image IM20 that is predicted to have a high possibility of containing a cross road area in advance. As a result, it is possible to reduce a processing load related to the detection of the cross road area.

The second detector 132 may realize, for example, the function of AI and the function of a predefined model in parallel. For example, the function of “detecting a cross road area” may be realized by detecting a cross road area using deep learning or the like and detecting a cross road area using predefined determination processing (for example, determination processing based on pattern matching) in parallel for the front image IM10 and the rear image IM20, and scoring both to evaluate them comprehensively.

When a specific road structure such as a traffic signal or a crosswalk is detected based on the front image IM10 or the rear image IM20, the second detector 132 may perform detection processing of the cross road area within a range of a predetermined distance from a position where the road structure is detected. The second detector 132 may refer to the map information stored in the storage 170 on the basis of positional information of the vehicle M, and perform detection processing of the cross road area when the position of the vehicle M is close to a position where a cross road is likely to be present, such as a crossover point or a T-junction (when the position of the vehicle M is within a predetermined distance). The positional information of the vehicle M is acquired, for example, by a position sensor (not shown) mounted in the vehicle M. The position sensor acquires positional information (longitude and latitude information) from, for example, a global positioning system (GPS) device. The position sensor may also acquire the positional information using a global navigation satellite system (GNSS) receiver of a navigation device (not shown) mounted in the vehicle M. As a result, the detection processing is executed in areas where the cross road area is likely to be present, making it possible to detect the cross road area more efficiently.

In the example of FIG. 4, the second detector 132 detects cross road areas AR20L and AR20R from the front image IM10. The second detector 132 may recognize separately between the cross road area AR20R that connects to the host road area AR10F on the right side and the cross road area AR20L that connects to the host road area AR10F on the left side. When a cross road area is included in the rear image IM20, the second detector 132 also detects that area.

The first feature point extractor 140 extracts feature points of the host road areas AR10F and AR10R detected by the first detector 130 from the feature points (the groups of feature points) extracted by the extractor 120. The second feature point extractor 142 extracts feature points of the cross road areas AR20L and AR20R detected by the second detector 132 from the feature points extracted by the extractor 120.

### [Calibrator]

Next, image calibration processing by the calibrator 150 will be specifically described. For example, the calibrator 150 calibrates an image when the feature points of the host road area and the cross road area are extracted continuously for a predetermined number of frames or more from image frames of different time for at least one of the front image IM10 and the rear image IM20. The predetermined number of frames may be a fixed number, or may be set variably according to traveling situations such as a road shape of a lane in which the vehicle M is traveling, a speed of the vehicle M, and a traveling direction.

For example, the calibrator 150 detects a movement of feature points between frames on the basis of changes in positions of the feature points over time of the host road area (for example, the host road areas AR10F and AR10R shown in FIG. 4) included in two image frames of the front image IM10 and the rear image IM20 at different times, and performs optical flow processing to represent the detected movement using a vector (a motion vector). The motion vector includes, for example, information on a direction and an amount of movement (an amount of displacement). A time interval (cycle) between two different image frames for acquiring the motion vector may be a period (or an integer multiple of the period) of the image frames acquired by the acquirer 110, and may be set variably on the basis of the speed of the vehicle M, the size of the host road area, and the like.

Instead of using all the feature points included in the host road areas AR10F and AR10R, feature points used in optical flow processing may be thinned out to a predetermined number or less. In this case, the calibrator 150 may divide the host road areas AR10F and AR10R into a plurality of divided areas and adjust the number of feature points for each divided area to be equal to or greater than a lower limit value and equal to or less than an upper limit value. By reducing the number of feature points used in the optical flow processing, a processing load can be reduced.

The calibrator 150 sets a normal vector perpendicular to a road surface of the host road on the basis of the motion vector obtained by optical flow processing and the traveling direction of the vehicle M at a time between two different image frames. For example, the calibrator 150 extracts a plurality of motion vectors from the host road area AR10F acquired from the front image, sets the road surface (plane) of the host road on the basis of directions of the plurality of extracted motion vectors (directions corresponding to the traveling direction of the vehicle M), and sets a normal vector to the set road surface. The calibrator 150 similarly sets a normal vector to the road surface of the host road for the host road area AR10R acquired from the rear image.

Then, the calibrator 150 calibrates an image so that a deviation between normal vectors of the host road areas AR10F and AR10R in the camera coordinate system and a normal vector of the actual road surface (that is, a reference normal vector perpendicular to a horizontal plane) is equal to or less than a threshold value. In this embodiment, since the front camera 12 and the rear camera 14 are integrally configured, directions of deviation of the front image and rear image are opposite. In other words, when the normal vector of the front image with respect to the host road area AR10F is deviated to the right with respect to the reference normal vector, the normal vector of the rear image with respect to the host road area AR10R is deviated to the left with respect to the reference normal vector. Therefore, the calibrator 150 performs calibration corresponding to each of the front image and the rear image.

Since the host road areas AR10F and AR10R are areas that extend above and below the image (in the forward or rearward direction of the vehicle M), the calibrator 150 mainly performs calibration in a pitch direction of the vehicle M (or the imaging device 10) using the host road areas AR10F and AR10R. As a result, more appropriate calibration can be performed in the pitch direction.

Similarly, the calibrator 150 performs optical flow processing to extract a motion vector on the basis of changes in positions of feature points over time of the cross road areas (for example, the cross road areas AR20L and AR20R shown in FIG. 4) included in two image frames of the front image IM10 and the rear image IM20 at different times. In this case, the calibrator 150 may thin out the feature points used in the optical flow processing, or may divide the cross road areas AR20L and AR20R into a plurality of divided areas and adjust the number of feature points for each divided area to be equal to or greater than a lower limit value and equal to or less than an upper limit value.

As described above, the calibrator 150 sets a normal vector for a road surface of the cross road on the basis of the motion vector and the traveling direction of the vehicle M at a time between the two different image frames, and calibrates an image so that a deviation between the set normal vector and the reference normal vector is equal to or less than a threshold value. Since the cross road areas AR20L and AR20R are areas that extend to left and right of the image (the lateral direction of the vehicle M), the calibrator 150 mainly performs calibration in a roll direction of the vehicle M (or the imaging device 10 mounted in the vehicle M) using the cross road areas AR20L and AR20R. As a result, more appropriate calibration can be performed in the roll direction.

As described above, the calibrator 150 performs calibration in the pitch direction on the basis of the feature points included in the host road area, and performs calibration in the roll direction on the basis of the feature points included in the cross road area. When a plurality of normal vectors are present, the calibrator 150 may perform calibration by comparing an average of the normal vectors with a reference normal vector, or may perform calibration so that errors (a least squared error) between the plurality of normal vectors and the reference normal vector is equal to or less than a threshold value.

The calibrator 150 may acquire information related to the calibration as calibration parameters, and the coordinate converter 160 may calibrate coordinate conversion parameters used when coordinate conversion is performed so that a coordinate system of an image is converted from the camera coordinate system to a different coordinate system (for example, a bird's-eye view coordinate system). As a result, more accurate coordinate conversion can be performed when coordinate conversion of an image is performed.

### [Coordinate Converter]

Next, processing of the coordinate converter 160 will be described. For example, the coordinate converter 160 performs coordinate conversion from the camera coordinate system of the image acquired by the acquirer 110 to the bird's-eye view coordinate system. In this case, the coordinate converter 160 performs coordinate conversion by adding parameters required for calibration by the calibrator 150 (calibration parameters in the pitch direction and the roll direction) to a predetermined reference coordinate conversion parameter.

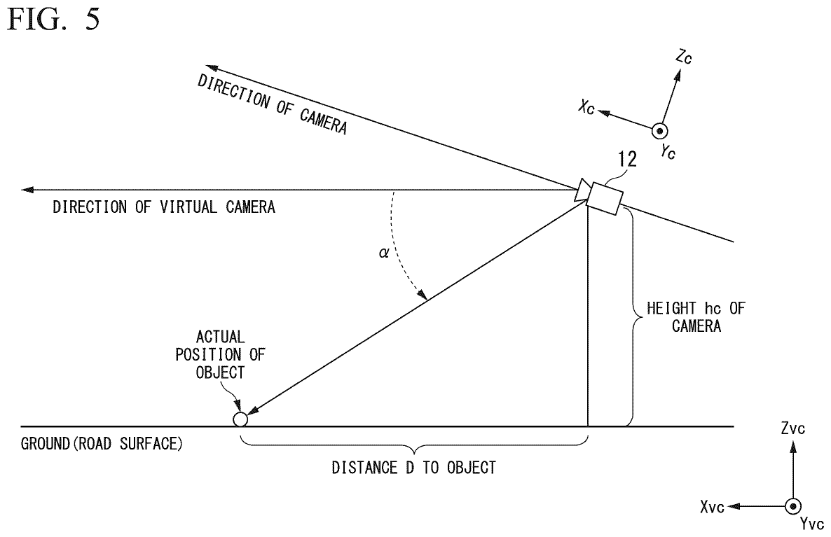

FIG. 5 is a diagram for describing the coordinate conversion processing in the embodiment. For example, three-dimensional axes of the camera coordinate system captured by the imaging device 10 (the front camera 12 in the example of FIG. 5) are [Xc, Yc, Zc], and a virtual camera coordinate system horizontal to the ground (a moving road surface) facing the traveling direction of the vehicle M is [Xvc, Yvc, Zvc]. Here, Xvc indicates the traveling direction of the vehicle M, Yvc indicates the lateral direction of the vehicle M, and Zvc indicates a vertical direction of the vehicle M. When a roll angle relative to the vehicle M is θ, the pitch angle is ρ, and a yaw angle is φ, then each angle [θ, ρ, φ] indicates a rotation angle around each axis of the virtual camera coordinate system [Xvc, Yvc, Zvc]. The roll angle θ and the pitch angle ρ at this time are values calibrated by the calibrator 150. The calibrator 150 performs coordinate conversion (rotation) from the camera coordinate system to the virtual camera coordinate system parallel to the ground facing the traveling direction, for example, using the following Equation (1).

$$[ Math 1 ]$$

$$[ \begin{matrix}{X}_{υ c} \\ {Y}_{υ c} \\ {Z}_{υ c}\end{matrix} ] = {R}_{Z} {R}_{Y} {R}_{X} [ \begin{matrix}{X}_{c} \\ {Y}_{c} \\ {Z}_{c}\end{matrix} ] \qquad ( 1 )$$

Degrees of rotational freedom Rx, Ry, and Rz for each axis in Equation (1) are derived using the following equations (2) to (4).

$$[ Math 2 ]$$

$${R}_{x} = [ \begin{matrix}1 & 0 & 0 \\ 0 & cos θ & - sin θ \\ 0 & sin θ & cos θ\end{matrix} ] \qquad ( 2 )$$

$${R}_{y} = [ \begin{matrix}cos ρ & 0 & sin ρ \\ 0 & 1 & 0 \\ - sin ρ & 0 & cos ρ\end{matrix} ] \qquad ( 3 )$$

$${R}_{z} = [ \begin{matrix}cos ϕ & - sin ϕ & 0 \\ sin ϕ & cos ϕ & 0 \\ 0 & 0 & 1\end{matrix} ] \qquad ( 4 )$$

The recognizer 20 recognizes a surrounding situation, such as positions of objects present in the periphery of the vehicle M, using an image (calibrated image) processed by the image processing device 100. For example, the recognizer 20 recognizes the position of an object when an image in the calibrated camera coordinate system is converted into that in the bird's-eye view coordinate system.

For example, as shown in FIG. 5, when the ground (the road surface) is always flat (a variation angle is within an allowable range), the recognizer 20 recognizes an azimuth angle and a distance in the bird's-eye view coordinate system for an object in the camera coordinate system as viewed from the front camera 12. In this case, the recognizer 20 calculates, for example, a depression angle α (an angle at which an object is viewed from above when expressed in polar coordinates based on an orientation of the virtual camera) using the following equation (5), and calculates an azimuth angle β using

$$“ β = {tan}^{- 1} ( Yvc / Xvc ) . ”$$

$$[ Math 3 ]$$

$$α = {cos}^{- 1} \frac{{Z}_{υc}}{\sqrt{{X}_{υ c}^{2} + {Y}_{υ c}^{2} + {Z}_{υ c}^{2}}} \qquad ( 5 )$$

When an installation position (a height hc) of the front camera 12 is set in advance, the recognizer 20 uses the depression angle α and the height hc to calculate the distance D from the vehicle M (more specifically, a position of the front camera 12 mounted in the vehicle M) to the object according to “D=hc/tan α.” By performing these types of processing on the objects in the periphery of the vehicle M, the positions of the objects in the periphery of the vehicle M in the bird's-eye view coordinate system and the distance to the objects can be more appropriately recognized.

The notification controller 40 may generate an image of the surrounding situation of the vehicle M after conversion into the bird's-eye view coordinate system, and notify the occupant of the generated image via the terminal device T. As a result, the accurate surrounding situation can be displayed to the occupant in a display format that is easy for the occupant to understand.

As described above, in the embodiment, image calibration (for example, calibration of coordinate conversion parameters from the camera coordinate system to the bird's-eye view coordinate system) is performed based on the host road area included in both the front image IM10 and the rear image IM20, so that more accurate calibration can be achieved. According to the embodiment, for example, by performing calibration on the basis of image information from the front camera 12 and the rear camera 14 actually mounted in the vehicle M, it is possible to suppress erroneous recognition of images in the pitch direction and the roll direction due to installation misalignment and product-to-product variation. Therefore, more appropriate object recognition and driving assistance can be performed. In particular, when calibration of a camera image is performed based on the road area, the calibration may not be performed appropriately in the roll direction because a host lane area is narrow in the lateral direction. Therefore, in the embodiment, more appropriate calibration can be performed even in the roll direction by using a cross road area that crosses the host road.

### [Processing Flow]

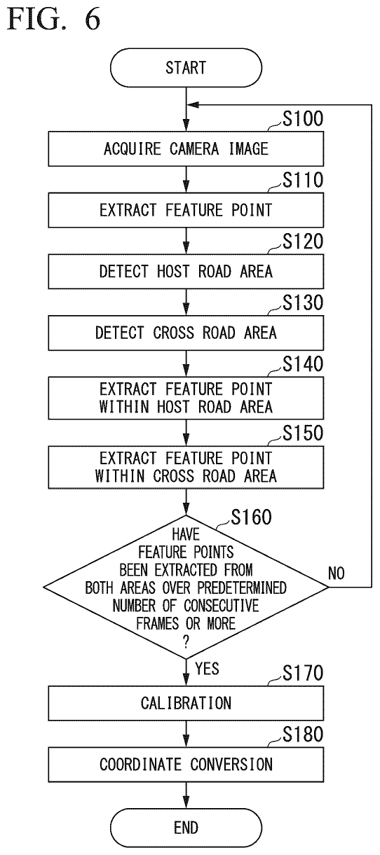

FIG. 6 is a flowchart which shows an example of a flow of processing executed by the image processing device 100 of the embodiment. The processing of FIG. 6 may be executed at a predetermined timing, such as when the imaging device 10 starts traveling after being attached to the vehicle M, or at a predetermined cycle. In the example of FIG. 6, the acquirer 110 acquires camera images (a front image and a rear image) from the imaging device 10 (the front camera 12 and the rear camera 14) (step S100). Next, the extractor 120 extracts feature points from the acquired camera images (step S110). Next, the first detector 130 extracts a host road area from the camera image (step S120). Next, the second detector 132 extracts a cross road area from the camera image (step S130).

Next, the first feature point extractor 140 extracts feature points within the host road area from among the feature points extracted in the processing of step S110 (step S140). Next, the second feature point extractor 142 extracts feature points within the host road area from among the feature points extracted in the processing of step S110 (step S150).

Next, the calibrator 150 determines whether feature points have been extracted from both the host road area and the cross road area over a predetermined number of consecutive frames or more (step S160). When it is determined that feature points have not been extracted from both areas over a predetermined number of consecutive frames or more, the processing returns to step S100. When it is determined that feature points in both areas have been extracted over a predetermined number of consecutive frames or more, the calibrator 150 calibrates images in the pitch and roll directions on the basis of the extracted feature points (step S170). Next, coordinate converter 160 performs coordinate conversion of the image based on a result of the calibration (step S180). As a result, processing of this flowchart is executed.

In the example of FIG. 6, processing of steps S110 to S130 may be executed in an order different from that shown in FIG. 6, and may be executed in parallel by a multi-processor or the like. The same will be applied to steps S140 and S150.

In the example of FIG. 6, in the processing of step S160, calibration is performed when feature points are extracted from both the host road area and the cross road area over a predetermined number of consecutive frames or more, but the calibrator 150 may perform calibration only in the pitch direction of the vehicle M when feature points are extracted from the host road area over a predetermined number of consecutive frames or more. The calibrator 150 may perform calibration only in the roll direction when feature points are extracted from the cross road area over a predetermined number of consecutive frames or more.

### Modified Example

In an embodiment, instead of extracting feature points from an entire image as described above and extracting feature points of the host road area and the cross road area among the extracted feature points, the host road area and the cross road area contained in the image may be extracted first, and feature points may be extracted from each extracted road area.

In the embodiment, the calibrator 150 may calibrate the image when a predetermined area or more of the host road area and the cross road area are extracted from the front image or the rear image. As a result, a normal vector to a road surface can be acquired more accurately from a relatively wide road area, and therefore more appropriate calibration can be performed.

In the embodiment, the image processing device 100 may perform correction processing such as aberration correction and distortion correction for the front camera 12 and the rear camera 14. In the embodiment, instead of (or in addition to) the rear image, an image including the lateral direction of the vehicle M (a side image or side image) may be used.

According to the embodiment described above, the image processing device 100 includes an acquirer 110 that acquires an image of the periphery of the vehicle M (an example of a mobile object) from an imaging device mounted in the vehicle M, an extractor 120 that extracts feature points from the image acquired by the acquirer 110, a first detector 130 that detects a travel road area along which the vehicle M moves from the image, a second detector 132 that detects a cross road area that crosses the moving road area from the image, a first feature point extractor 140 that extracts, from the feature points extracted by the extractor 120, a feature point of the moving road area detected by the first detector 130 as a first feature point, a second feature point extractor 142 that extracts, from the feature points, a feature point of the cross road area detected by the second detector 132 as a second feature point, and the calibrator 150 that calibrates the image on the basis of the first feature point and the second feature point, and thereby more appropriate calibration can be performed on the image captured by the imaging device 10 mounted in the vehicle M.

Specifically, according to the embodiment, for example, since an image is calibrated on the basis of the feature points of the host vehicle road area and the cross road area using images in the forward and rearward directions of the vehicle M, more accurate calibration can be performed by using more pieces of information. By including the rear image, it becomes easier to acquire the cross road area in particular. According to the embodiment, for the roll direction of the vehicle M, more accurate calibration in the roll direction can be performed by using information obtained from the host road area extending in the forward and rearward directions as viewed from the vehicle M (a normal vector to the road surface of the host road). For the pitch direction of the vehicle M, more accurate calibration in the pitch direction can be performed by using information obtained from the cross road area extending in leftward and rightward directions as viewed from the vehicle M (a normal vector to the road surface of the cross road).

According to the embodiment, even if there is a misalignment in the mounting of the imaging device in the vehicle M or there is a product variation in the imaging device, by performing calibration using the front image and rear image captured by the imaging device mounted in the vehicle M, more appropriate conversion can be performed when coordinate conversion of an image is performed, and a relative position and a relative distance to an object in the periphery of the vehicle M can be recognized more accurately. Therefore, recognition of these makes it possible to execute more appropriate driving assistance.

The embodiments described above can be expressed as follows.

An image processing device includes a storage medium for storing computer-readable instructions and a processor connected to the storage medium, in which the processor executes the computer-readable instructions to acquire an image of a periphery of a mobile object from an imaging device mounted on the mobile object, extract feature points from the acquired image, detect a moving road area in which the mobile object moves based on the image, detect a cross road area that crosses the moving road area based on the image, extract a feature point of the moving road area as a first feature point among the extracted feature points, extract a feature point of the cross road area as a second feature point among the feature points, and calibrate the image on the basis of the first feature point and the second feature point.

Although a mode for carrying out the present invention has been described above using the embodiment, the present invention is not limited to the embodiment, and various modifications and substitutions can be made within a range not departing from the gist of the present invention.

What is claimed is:

1. An image processing device comprising:
an acquirer configured to acquire an image in a periphery of a mobile object from an imaging device mounted on the mobile object;
an extractor configured to extract feature points from an image acquired by the acquirer;
a first detector configured to detect a moving road area in which the mobile object moves based on the image;
a second detector configured to detect a cross road area that crosses the moving road area based on the image;
a first feature point extractor configured to extract a feature point of a moving road area detected by the first detector as a first feature point among feature points extracted by the extractor;
a second feature point extractor configured to extract a feature point of a cross road area detected by the second detector as a second feature point among the feature points; and
a calibrator configured to calibrate the image on the basis of the first feature point and the second feature point.

2. The image processing device according to claim 1,
wherein the acquirer uses the imaging device to acquire at least an image of a view in a forward direction of the mobile object and an image of a view in a direction different from the forward direction.

3. The image processing device according to claim 1,
wherein the calibrator calibrates an image of the mobile object in a pitch direction on the basis of the first feature point, and calibrates an image of the mobile object in a roll direction on the basis of the second feature point.

4. The image processing device according to claim 1,
wherein the calibrator calibrates a coordinate system of the image when a first feature point in the cross road area and a second feature point in the moving road area are extracted over a predetermined number of consecutive frames or more from image frames acquired by the acquirer in a predetermined cycle.

5. The image processing device according to claim 1,
wherein the calibrator calibrates coordinate conversion parameters that convert from an image coordinate system based on the view in the forward direction of the mobile object included in the image to a bird's-eye view coordinate system in which the mobile object is viewed from above.

6. The image processing device according to claim 1,
wherein the imaging device is integrally configured to include an imager that captures an image of view in the forward direction of the mobile object and an imager that captures an image of a view in a direction different from the forward direction.

7. An image processing method comprising:
by a computer,
acquiring an image in a periphery of a mobile object from an imaging device mounted on the mobile object;
extracting feature points from the acquired image;
detecting a moving road area in which the mobile object moves based on the image;
detecting a cross road area that crosses the moving road area based on the image;
extracting a feature point of the moving road area as a first feature point among the extracted feature points;
extracting a feature point of the cross road area as a second feature point among the feature points; and
calibrating the image on the basis of the first feature point and the second feature point.

8. A computer-readable non-transient storage medium that has stored a program causing a computer to execute:
acquiring an image in a periphery of a mobile object from an imaging device mounted on the mobile object;
extracting feature points from the acquired image;
detecting a moving road area in which the mobile object moves based on the image;
detecting a cross road area that crosses the moving road area based on the image;
extracting a feature point of the moving road area as a first feature point among the extracted feature points;
extracting a feature point of the cross road area as a second feature point among the feature points; and
calibrating the image on the basis of the first feature point and the second feature point.
